(19) United States
(12) Patent Application Publication
(10) Pub. No.: US 2026/0233798 A1
(43) Pub. Date: Aug. 13, 2026

(54) 3 in 1 toolless transforming quadracycle

(71) Applicant: Albert C Burmaster, III, Saint Bernard, LA (US)

(72) Inventor: Albert C Burmaster, III, Saint Bernard, LA (US)

(21) Appl. No.: 19/049,713

(22) Filed: Feb. 10, 2025

(51) Int. Cl. B62K 13/06; B62M 6/40; B62M 6/85

(52) U.S. Cl. CPC B62K 13/06; B62M 6/40; B62M 6/85

(57) ABSTRACT

A versatile 3 in 1 vehicle: 1. A bicycle, 2. An e-bike, and when combined, 3. A quadracycle. These two primary components, (1 & 2) along with a few additional parts, seamlessly transform into a three-person quadracycle (3) that can be powered by human power or motor assistance. Impressively, the transformation is toolless and takes just minutes to preform, making it an innovative and adaptable mode of transportation. Its lightweight, toolless and foldable design allows for effortless assembly/disassembly, making storage and transport easy-whether packed into its compact boxes or carried on a bike rack.

### CROSS-REFERENCE TO RELATED APPLICATIONS

Application number; This application claims the benefit of PPA 63/554,975 filed on Feb. 17,2024 Instant tool-less quadracycle

### REFERENCED PATENTS

a. U.S. Pat. No. 8,342,555, b. U.S. Pat. No. 7,207,407, c. U.S. Pat. No. 9,656,714, d. U.S. Pat. No. 794373, e. U.S. 10,029,755

### FIELD OF INVENTION

The present invention relates to the field of 4 wheeled and 2 wheeled multi-passenger light vehicles, such as quadracycles, golf carts, side by sides, bikes and e-bikes.

### PROBLEM

Many people enjoy camping at campgrounds, RV resorts, parks, and events. While exploring these areas, it's common for campers to use light vehicles such as golf carts, bikes, and e-bikes to get around efficiently. These vehicles allow them to cover large distances in less time.

Golf carts, quadracycles, and side-by-sides are particularly convenient for transporting multiple passengers comfortably, whereas bikes and e-bikes are better suited for individuals due to their less comfortable seating. However, golf carts and side-by-sides have limitations, as they rely solely on gas or electric motors, which can run out of fuel or battery power, potentially leaving users stranded, and the side-by-side use gasoline engines that are noisy.

But one of the biggest challenges with golf carts, quadracycles, and side-by-sides is transportation. These vehicles are heavy and not designed for disassembly, making them difficult to transport from one location to another.

Transporting these vehicles presents several challenges, as outlined below:
1. Utility Trailer—Purchasing a utility trailer is an option, but it comes with high cost and maintenance requirements. It must be towed behind a truck or car, which requires a skill not everyone possesses. If you're already towing a camper, you would need to triple tow by attaching the utility trailer behind it-an extremely dangerous practice that is even illegal in some states. Additionally, storing the trailer at a campsite or home can be difficult due to space limitations, as many campsites have restricted parking areas.
2. Toy Hauler—A specialized camper, known as a toy hauler, allows you to transport a golf cart, side-by-side, or quadracycle inside the camper. However, this significantly reduces the available living space, making it a less practical solution for many campers.
3. Truck Bed Transport—If your truck bed is large enough and your golf cart is small enough (considering that the average golf cart is 8 feet long while the average truck bed is only 6.5 feet), you could use ramps to load it into the truck bed. However, this method poses a risk of serious injury during loading and unloading. It also takes up most of the truck's cargo space needed for other gear and directly reduces the vehicle's towing capacity.
4. Maintenance and Repair Cost—Golf carts and side-by-sides are costly to maintain and repair, adding another layer of inconvenience to their use.
5. Golf carts and side-by-sides are on average 50″ to 56″ wide, while most side walks are between 42″ and 48″ wide, this difference makes for ruined grass and unhappy neighbors.

Currently, there is no widely available solution that efficiently combines the features of a bike, an e-bike, and easy to transport multi-passenger, motorized, and pedal-powered upright-seated quadracycle. An ideal alternative would be a transformable vehicle that requires no tools for setup or disassembly and can be easily stored in maneuverable storage boxes or transported via a bumper-mounted bike rack and bag.

### SOLUTION

This invention addresses the problem by introducing a lightweight, four-wheeled, upright-seated quadracycle designed for three or more passengers. It can be powered either by pedaling or electric motor and offers a toolless assembly and disassembly process that takes just minutes and requires only one person. It has a small enough footprint that fits nicely on most sidewalks. Its quiet operation makes it perfect for enjoying nature.

For transportation, there's no need for a utility trailer or specialized camper. The quadracycle can be stored in two compact boxes that fit into SUV's, truck beds, or the storage compartments of campers and RV's. Alternatively, it can be mounted on a two-bike carrier rack, with additional components stored in a bag all attached to the bumper of a car, truck, RV or camper etc.

The design is highly versatile, allowing for the toolless transformation between different configurations:
1. A single-user bicycle, pedal power only 2. A single-user e-bike, powered by either pedaling or electric motor 3. A multi-passenger quadracycle, powered by either pedaling or electric motor It can be recharged using solar power or an AC charger. Weighing seven times less than a golf cart, it is significantly easier to transport. Additionally, manufacturing and maintenance cost are minimal, as it primarily uses common e-bike and bicycle components.

### DESCRIPTION OF DRAWINGS

Note for simplicity of illustration, bearings, O-rings, nuts, bolts, washers, and minutiae of common cycling industry hardware are not depicted as they are known to those with the skill in the art. Where they are shown, it is purely for illustrative purposes and not intended to capture all embodiments of the invention disclosed.

FIG. 1 is a front side orthogonal view; it shows the invention in the Quadracycle configuration.

FIG. 2 is a top side orthogonal view; it shows the invention in the Quadracycle configuration. The seat and canopy are removed for clarity.

FIG. 3 is a left perspective view; it shows the invention in the Quadracycle configuration. The canopy, middle passenger footrest and secondary frame handlebars are not shown for clarity.

FIG. 4 is a rear side orthogonal view; it shows the invention in the Quadracycle configuration. The middle passenger footrest is removed for clarity.

FIG. 5 is a right-side orthogonal view of the primary frame; it shows the invention in the single seat e-bike mode.

FIG. 6 is a top side orthogonal view of the front connecting bar.

FIG. 7A is a top side orthogonal view of the rear connecting bar.

FIG. 7B is a right-side orthogonal view of the rear connecting bar to highlight the anti-rotation button protrusion.

FIG. 8 is a right-side orthogonal view of either the front or rear connecting bar, to show detail of the locating annulus and the anti-rotation button.

FIG. 9 is a left perspective view of the primary frame rear half.

FIG. 10 is a front perspective view of the lower half of the Quadracycle seat frame.

FIG. 11 is a right-side orthogonal view of the primary frame and the Quadracycle seat frame.

FIG. 12 is a right perspective view of the armrest assembly.

FIG. 13 is a right perspective view of the two frames rear halves showing connection to armrest.

FIG. 14A is a front side orthogonal view of the armrest assembly.

FIG. 14B is a front side orthogonal view of the armrest assembly in the folded position.

FIG. 15 is a bottom side orthogonal view of the armrest positioning clips and the hinges.

FIG. 16A is a front side orthogonal view of the front fork details.

FIG. 16B is a front side orthogonal view of the draglink and its connection to the forks.

FIG. 17A is a right-side orthogonal view of the secondary frame in the bicycle mode, noting the removable handlebars.

FIG. 17B is a front side orthogonal view of the front fork of the secondary frame, noting the secondary toolless quick-release stem riser.

FIG. 18A is a left perspective view of a toolless connection clamp.

FIG. 18B is a right-side orthogonal view of a toolless connection clamp and its connection to the frame, noting the anti-rotation button's location.

FIG. 19 is a front perspective view of the toolless handlebar clamping brake lever for the secondary frame front and rear brakes.

FIG. 20 is a front side orthogonal view of the front wheel with the toolless quick release hub skewer.

FIG. 21 is a right-side orthogonal view of the toolless adjustable quill, noting direction of toolless adjustment lever to release locked position.

FIG. 22A is a top perspective view of the folded position, toolless folding handlebar.

FIG. 22B is a front perspective view of the toolless folding, connected to the stem clamp, toolless adjustable quill, quill stem adapter and the head tube, note that this is the primary frame set up as it stays attached.

FIG. 23A is a top side orthogonal view of the storage box with the primary frame in it, noting the front wheel is removed from the fork to save room.

FIG. 23B is a right-side orthogonal view of the storage box with the cover on, showing wheel and handle.

FIG. 24 is a left side orthogonal view of a bike carrier connected to a camper bumper with the Quadracycle halves on it.

FIG. 25 is a front side orthogonal view of a d-ring locking pin.

FIG. 26 is a front side orthogonal view of a spring button tubing lock.

FIG. 27 is a front side orthogonal view of a toolless joint nut connector, an alternative toolless connection type that uses an overside threaded connection.

FIG. 28A is a right-side orthogonal view of an alternative, toolless connection for head tube to frame, noting the top tube frame of both the primary frame and secondary frame, showing connected.

FIG. 28B is a top side orthogonal view of FIG. 28A, showing connected.

FIG. 28C is a right-side orthogonal view of FIG. 28A, showing separated.

FIG. 28D is a top side orthogonal view of FIG. 28A, showing separated.

FIG. 29A is a left side orthogonal view of an alternative, offset chain drive steering setup.

FIG. 29B is top side orthogonal view of an alternative, offset linkage and fulcrum steering.

FIG. 29C is a top side orthogonal view of FIG. 29A.

FIG. 30 is a left side perspective view of an alternative, rear facing seat that is used in place of the cargo rack.

### DRAWINGS—REFERENCE NUMERALS

30. flexible solar panel
32. canopy
34. canopy pole
36. three person folding seat
37. seatbelts
38. armrest
40. front connecting bar
42. folding pedal
44. front fork
46. front wheel
48. draglink
50. rear connecting bar
52. middle passenger footrest bar
53. footrest bar mounting tabs
54. front brake
56. head light
58. hand brake lever
60. handlebar grip
62. toolless quick-release inboard clamp primary
64. crankshaft
66. middle passenger footrest pad
68. single seat receiving tube
70. toolless quick-release outboard clamp primary
72. primary frame
74. rear canopy attachment point
76. rear wheel
78. toolless quick-release primary seat frame clamp
79. quick-release push-button lock pin
80. toolless quick-release inboard clamp secondary
81. toolless quick-release outboard clamp secondary
82. secondary frame
84. secondary front seat frame attachment guide
85. toolless quick-release inboard clamp secondary
86. toolless quick-release outboard clamp secondary
88. front canopy attachment point
90. sprocket
92. secondary toolless quick-release stem riser
94. secondary handlebar attachment point
96. draglink mounting tab
98. toolless quick-release inboard clamp primary
100. toolless adjustable quill
101. quill stem adapter
102. tail light
104. emergency hand brake
106. rear brake
108. rear sprocket
110. rack attachment point
112. trailer hitch attachment point
114. cargo rack
116. d-pin
118. chain
120. e-bike footrest
122. toolless quick-release outboard clamp primary
124. mounting bracket
126. lithium battery
128. motor control box
129. thumb throttle
130. chain guide/tensioner
132. armrest positioning clips
134. primary front seat frame attachment guide
136. single person seat
138. footrest area
140. seat frame base
142. square tubing housing
144. seat connecting tube
146. seat hinge
148. electric hub motor
150. armrest assembly
152. kickstand
154. armrest folding hinge
156. connecting bar clamp area
158. anti-rotation button
160. locating annulus
162. adjustment lock nut
164. rod clevis end
166. clevis pin
168. hairpin cotter
170. head tube
172. steering sprocket
174. handlebar assembly
176. toolless quick-release secondary seat frame clamp
178. spring pin
180. cam lever
182. nut
184. anti-rotation tab
186. frame material
188. hinged moving plate
190. dual cable design
192. brake cables
194. steering chain
196. toolless handlebar clamping brake lever
198. brake engagement pin
200. toolless quick-release hub skewer
202. pivot point to handlebar
204. pivot point from quill
206. locking button
208. quill adjustment lever
210. toolless folding handlebar
212. pivot points
214. toolless joint nut connector
216. stem clamp
218. storage box
220. storage box handle
222. storage box wheel
224. storage box top
226. camper
228. 2 bike platform bike rack
230. trailer hitch receiver
232. spring button tubing lock
234. d-locking pin area
236. top tube frame
238. oversized head stud
240. steering shaft collar
242. steering tube extender
243. steering heim linkage rod
244. fulcrum plate
245. switch
246. fork suspension
248. rear facing seat
250. rear seat armrest
252. rear seat attachment bracket
254. rear seat attachment point

### DETAILED DESCRIPTION

This embodiment provides ease of transformation from bicycle (secondary frame 82) plus e-bike (primary frame 72) to quadracycle and from storage boxes to riding in just minutes. This is made possible because of its toolless assembly and modularity. Additionally, it is economical, as many of the components are standard bicycle parts, ensuring low-cost manufacturing, repairs and maintenance.

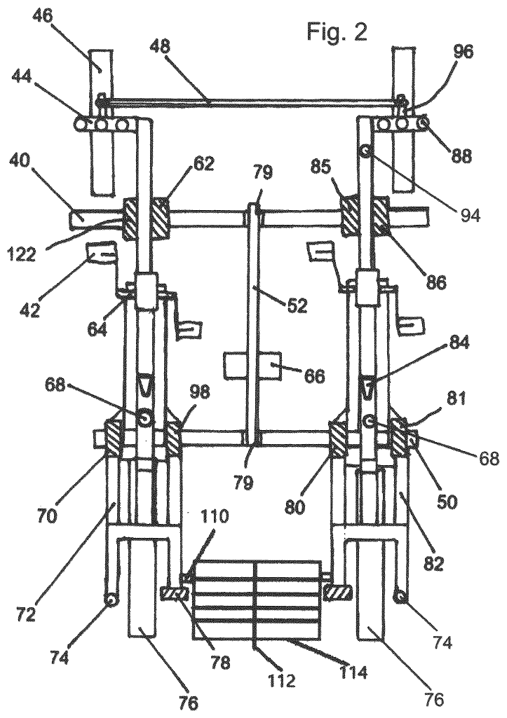

Quadracycle main parts. FIG. 2 illustrates the quadracycle embodiment, in this figure, the three-person folding seat 36 and canopy 32 are not shown to better view the lower features. Included are two frames, a primary frame 72 and a secondary frame 82, they can be made of tubing of the various shapes and materials used in bicycle frames.

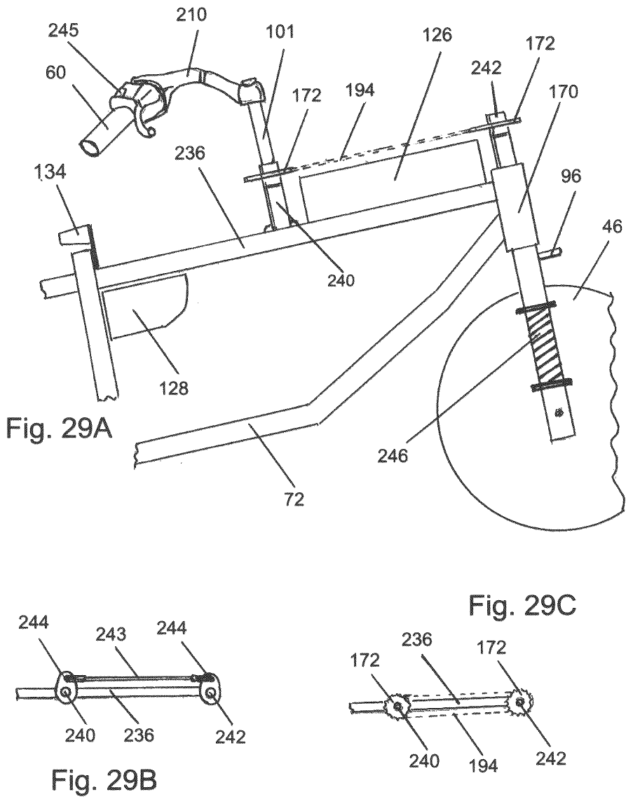

They are supported by rear wheels 76, which can be of smaller or larger diameters and widths, and front wheels 46, mounted on front forks 44 that can be suspension or rigid type, (FIG. 29A illustrates the front forks 44 with the optional fork suspension 246) the front wheels 46 can be of larger or smaller diameters and widths. The primary frame 72 and secondary frame 82 both use standard bicycle crankshaft 64 assembly and sprockets 90 with standard bicycle chains 118 and folding pedals 42 that are used to decrease overall width when folded for storage. Note in this view FIG. 2 the front track width is wider than the rear track width, this is purposely done to optimize stability and handling.

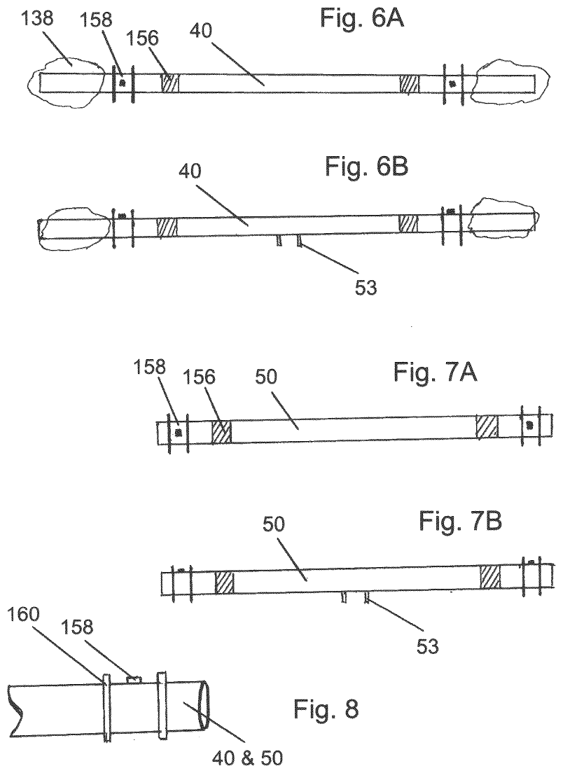

The two frames connected. Primary frame 72 and secondary frame 82 are structurally connected by the use of the front connecting bar 40 and the rear connecting bar 50, they are shown as cylindrical but can be made with any shape that is of proper tensile strength for this connection. The front connecting bar 40 is connected to the primary frame 72 with the use of toolless quick-release outboard clamp primary 122 and the toolless quick-release inboard clamp primary 62, the secondary frame 82 is connected by the use of the toolless quick-release outboard clamp secondary 86 and the toolless quick-release inboard clamp secondary 85. The front connecting bar 40 also extends out to allow it to be used as a footrest area 138 as noted in FIG. 6. The rear connecting bar 50 is connected to the primary frame 72 with the use of the toolless quick-release outboard clamp primary 70 and the toolless quick-release inboard clamp primary 98, the secondary frame 82 is connected to the toolless quick-release inboard clamp secondary 80 and the toolless quick-release outboard clamp secondary 81. With the use of the front connecting bar 40 and the rear connecting bar 50 the two frames 72 and 82 are joined to form a rigid quadracycle frame, as the four toolless quick-release clamps 122, 62, 70 and 98 are bolted to the primary frame 72 and the other four toolless quick-release clamps 80, 81, 85 and 86 are all connected to the secondary frame 82.

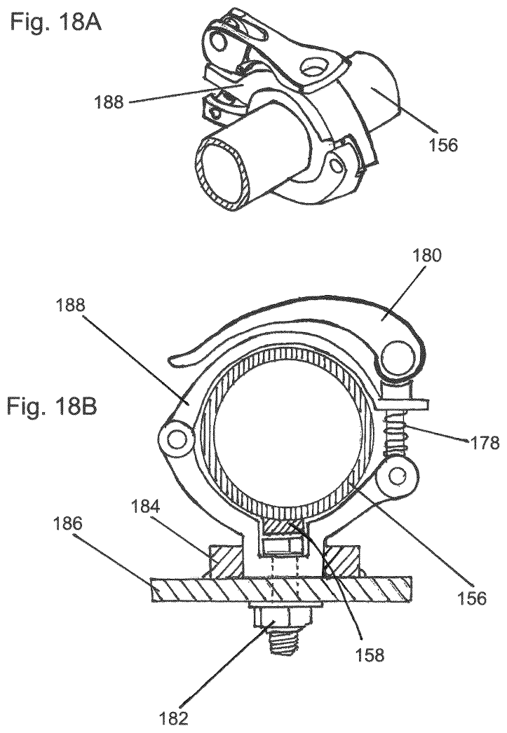

Clamps. These eight toolless quick-release clamps 122, 62, 70, 98, 80, 81, 85, and 86 plus the toolless quick-release primary seat frame clamp 78 and toolless quick-release secondary seat frame clamp 176 are the same and are illustrated in FIG. 18A and FIG. 18B, they are connected to the primary frame 72 and secondary frame 82 with a bolt and nut 182, the locations they are mounted utilize anti-rotation tabs 184 the FIG. 18B shows frame material 186 it can be any material the primary frame 72 and secondary frame 82 are made of. The way they operate is by first opening the cam lever 180 which releases tension, allowing the spring pin 178 to be tilted out of the way, then lifting of the hinged moving plate 188 to the side, so that the front connection bar 40 or rear connection bar 50 or the seat connecting tube 144 or the e-bike footrest 120 can be properly placed in the clamp with the anti-rotation button 158 that is made onto the front connecting bar 40 and rear connecting bar 50 fitting into the clamp lower half notch, as shown in the FIG. 18B, the locating annulus 160 are located on both sides of the clamp to stop any linear movement. Next, the hinged moving plate 188 can be closed over the top of the front connecting bar 40 or rear connecting bar 50 and the spring pin 178 can be placed over it and then the cam lever 180 can be tightened to complete the locking of the clamp, as illustrated in FIG. 18B, shown without the locating annulus 160. FIG. 6A, FIG. 6B, FIG. 7A, FIG. 7B and FIG. 18A all show a connecting bar clamp area 156 it is the shaded area that shows the location of the primary frame 72, toolless quick-release inboard clamp primary 62 and 98 and the secondary frame 82, toolless quick-release inboard clamp secondary 85, and toolless quick-release inboard clamp secondary 80 locations, it is just a clamped area that does not require the anti-rotation button 158 or the locating annulus 160 but is clamped for extra support.

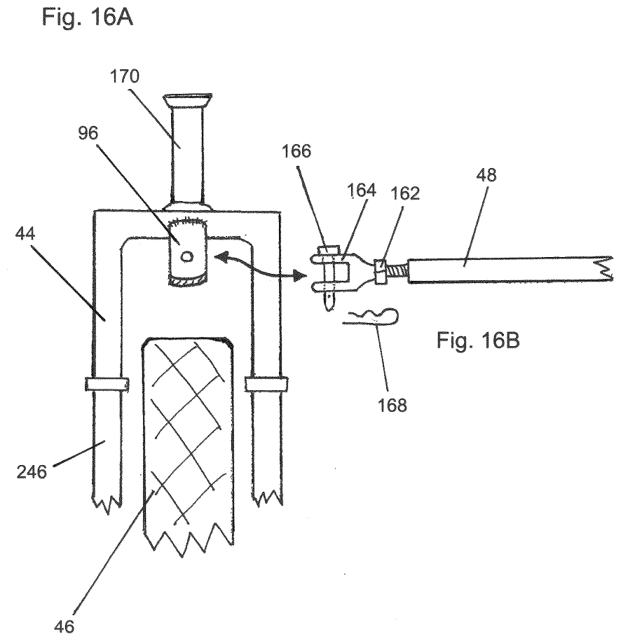

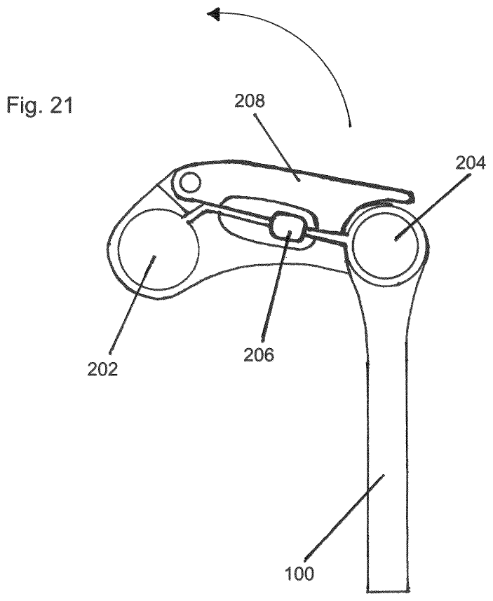

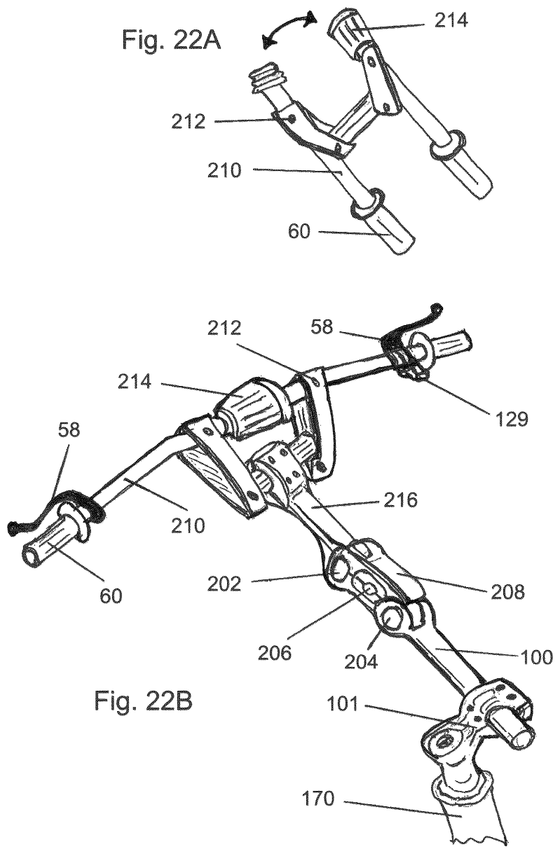

Steering. With the primary frame 72 and secondary frame 82 connected, the draglink 48 can be connected to the two front wheels 46 by connecting the rod clevis ends 164 FIG. 16B to the draglink mounting tabs 96 that are welded onto the front forks 44 via the clevis pins 166 and the hairpin cotters 168, allowing both front wheels 46 to be controlled as one, The draglink 48 as in FIG. 16B shows a adjustable lock nut 162 and the rod clevis end 164, it is threaded into the draglink 48 on both sides, it is used to make adjustments to the toe alignment of the front wheels 46 only as needed. Through the use of the primary frames 72 connection to the front fork 44 that is connected to the quill stem adaptor 101 in FIG. 22B, (the quill stem adaptor 101 stays on the primary frame 72, whether it is being used as an e-bike or quadracycle) which is connected to the toolless folding handlebar 210. (only folded when not in use, it is folded by loosening the toolless joint nut connector 214 and then folding them back via the pivot points 212) The toolless folding handlebars 210 also use handlebar grips 60 as shown. The steering is fully adjustable, via the toolless adjustable quill 100, as seen in FIGS. 21 and 22B it operates by first releasing the locking button 206 then lifting the quill adjustment lever 208, this allows the two pivot points, pivot point to handlebar 202 and pivot point from quill 204 to freely pivot, allowing adjustment of the toolless folding handlebar 210 to a comfortable position, then by lowering the quill adjustment lever 208, the position is locked. FIG. 22B, shows the stem clamp 216. It is attached to the toolless folding handlebar 210, and the toolless adjustable quill 100, it is used to add space between and as an adapter between the toolless folding handlebar 210 and the toolless adjustable quill 100.

Alternative steering, other steering embodiments can be used, FIGS. 29A, 29B, and 29C illustrate two. These alternative steering connections offset the distance from the toolless folding handlebar 210 to the quill stem adapter 101. (Therefore, not needing the stem clamp 216 to add distance.) In FIG. 29A and FIG. 29C the method used is with the use of steering sprockets 172 and steering chain 194, connected to the steering tube extender 242 on one side and the steering shaft collar 240 on the other side with the steering chain 194 connecting them together, this allows the quill stem adapter 101 to be placed in the steering shaft collar 240 then connected to the toolless folding handlebar 210. In FIG. 29B the same results are achieved by using a steering heim linkage rod 243, and fulcrum plates 244. For reference the top tube frame 236 is shown in FIGS. 29A, 29B and 29C.

Middle passenger comfort. FIG. 2 illustrates the use of a middle passenger footrest pad 66 it is part of the middle passenger footrest bar 52, it is connected to the front connecting bar 40 via the footrest bar mounting tabs 53 and with the use of a quick-release push button lock pin 79 or the attachment d-pin 116, that is inserted through holes (not illustrated) in the footrest bar mounting tabs 53 and a hole (not illustrated) in the middle passenger footrest bar 52, and the rear connecting bar 50 via the footrest bar mounting tabs 53 and with the use of a quick-release push button lock pin 79 or the attachment d-pin 116, that is inserted through holes (not illustrated) in the footrest bar mounting tabs 53 and a hole (not illustrated) in the middle passenger footrest bar 52, with the use of a quick-release push button lock pin 79 or the attachment d-pin 116. This is for the middle passengers' comfort, as they do not have pedals to rest feet on and they would be dangling.

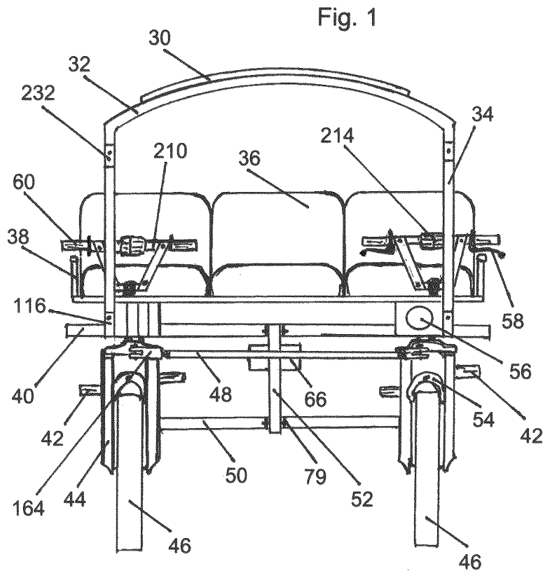

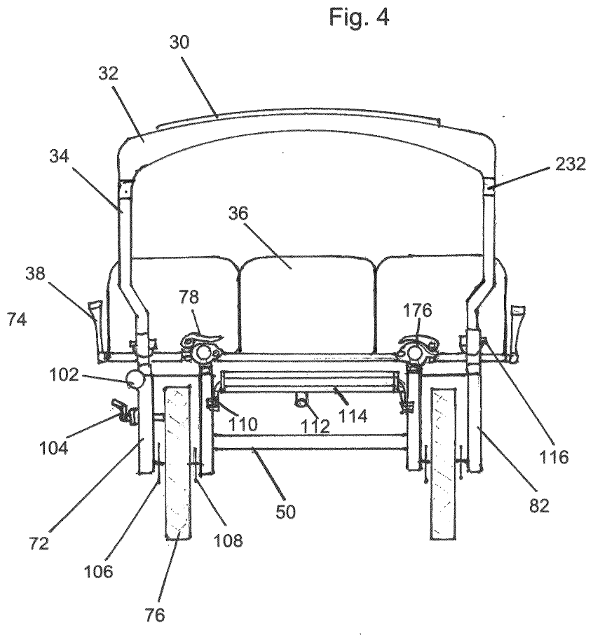

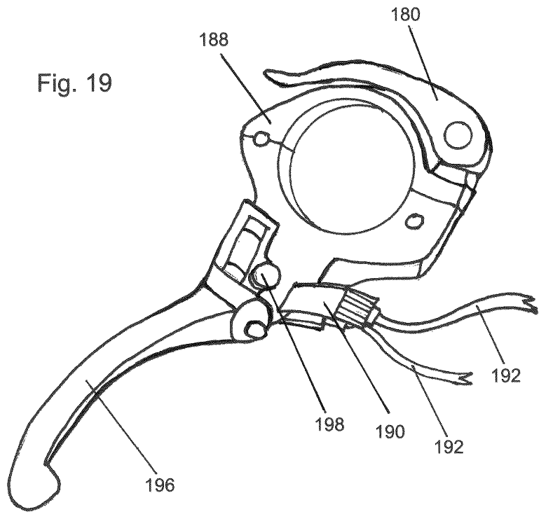

FIG. 1 illustrates the quadracycle embodiment, in this figure, it has a canopy 32 it is made of a waterproof fabric, (but in an alternative embodiment, could be made by using the storage box tops 224 connected together) connected to canopy poles 34 made of aluminum, carbon fiber, wood, or fiberglass they are connected to the primary frame 72 and secondary frame 82 at the rear canopy attachment points 74 and the front canopy attachment points 88 with the use of the attachment d-pins 116 as in FIG. 4 and spring button tubing locks 232 as noted in FIG. 1. Attached to the top of the canopy is the flexible solar panel 30. The flexible solar panel 30 is one way to charge the lithium battery 126, another is a standard battery charger (not illustrated). FIG. 1, notes headlight 56, it is connected to the lithium battery 126, and is switchable via. a switch 245 on the thumb throttle 129. FIG. 1 shows front brakes 54 along with the hand brake lever 58. The hand brake lever 58 mounted to the primary frame 72 left hand of the toolless folding handlebar 210 assembly is of a dual cable design 190, it controls the front brake 54 and rear brake 106 for the primary frame 72 and it is not removable. (it stays on the left side of the toolless folding handlebar 210) The tool-less handlebar clamping brake lever 196 in FIG. 19 is to be mounted on the right side of the primary frame 72, toolless folding handlebar 210. It is also a dual cable design 190, but it is removable, staying connected with the secondary frame 82 via the brake cables 192, when not used as a quadracycle, or when in storage boxes 218. It operates the secondary frame 82, rear brake 106 and the front brake 54, it is attached to the secondary frame 82 toolless folding handlebars 210 when use as a single seat bike. Both the hand brake lever 58, and toolless handlebar clamping brake lever 196, have brake engagement pins 198 to use as a park brake, (standard on most bikes) seen in FIG. 19.

FIG. 4 illustrates the quadracycle embodiment from the rear, it makes note of the three-person folding seat 36 and the toolless quick-release primary seat frame clamp 78 and the toolless quick-release secondary seat frame clamp 176. Also noted is the tail light 102 and the emergency hand brake 104, this is a standard manually operated wheel chair hand brake, mounted to the primary frame 72, it contacts and holds the primary frame 72 rear wheel 76, for parking or emergency stops. Also shown is the cargo rack 114 it is made of metal tubing and of the standard bicycle design, the cargo rack 114 rack attachment points 110, are located on the primary frame 72 and the secondary frame 82, the cargo rack slips into the rack attachment point 110 that are located on the frames 72 and 82 and a quick-release push button lock pin 79 or d-pin 116 is inserted to make the connection complete. FIG. 9 has a view of the rack attachment point 110.

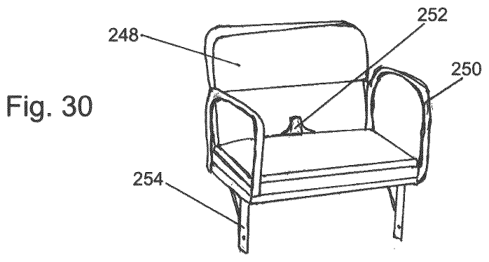

Built into the cargo rack 114 is a tab with a hole, it is used as a trailer hitch attachment point 112. It can be used to attach a trailer. Alternatively, the cargo rack 114 can be replaced with a rear facing seat 248, illustrated in FIG. 30, shown is a rear seat armrest 250, the rear seat attachment bracket 252, and the rear seat attachment point 254. It is connected by placing the rear seat attachment bracket 252 onto the seat frame base 140 of the three-person folding seat 36, then inserting the rear seat attachment point 254 onto the cargo rack attachment point 110 and using d-pins 116 to secure.

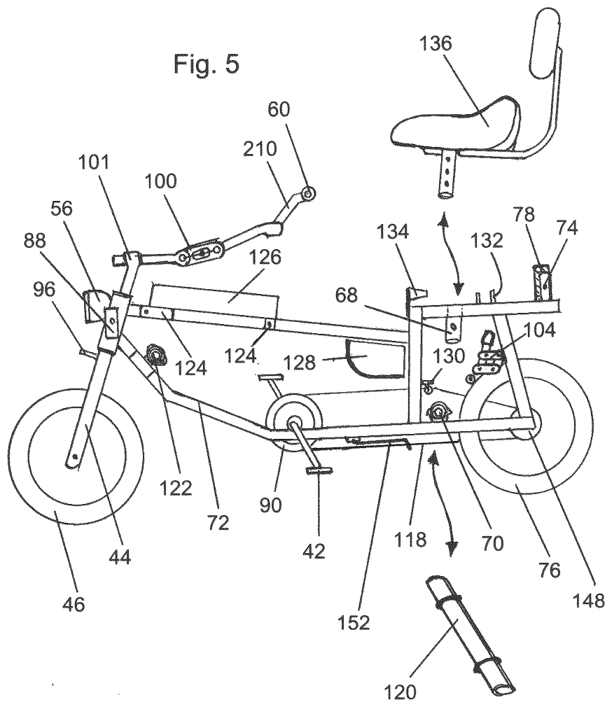

E-bike mode. FIG. 5 illustrates the embodiment as a stand-alone single seat e-bike embodiment. This uses the primary frame 72, it has everything needed built into it with the exception of the single person seat 136, the single person seat 136 slides into the single seat receiving tube 68 and an attachment D-pin 116 is inserted at the proper rider height position. The only other part to be added (but optional) is the e-bike footrest 120, that attaches to the toolless quick-release inboard and outboard clamps primary 70 and 98. It provides another place to rest the feet other than the folding pedals 42. The primary frame 72 also has an electric hub motor 148 built into the rear wheel, it can be of any type or power level, it could also be a gasoline engine version as well. The primary frame 72 has a sprocket 90 and crankshaft 64, along with a chain 118 and folding pedals 42. The primary frame 72 has a lithium battery 126, the lithium battery 126 is mounted to the primary frame 72 with a mounting bracket 124, it is bolted at one end and removable at the other end via a d-pin 116, this allows the lithium battery 126 to be tilted upwards and able to slide off of the battery mounting bracket 124 when needed to replace the lithium battery 126. It has a keyed lock (not shown) built into the lithium battery 126. That keeps it secured to the mounting racket 124. Alternatively, a type of battery adapter can be used that would allow for the use of cordless tool batteries, it would allow the owner to use batteries that they already own. Primary frame 72 has a mounted motor control box 128 located under the top tube 236, it is connected to the top tube 236 via hook and loop straps (not shown), and is wired to the electric hub motor 148, the lithium battery 126, the headlight switch 245, the crankshaft 64 (it connects to the crankshaft 64 to a sensor, not shown, used for motor assist function), and the thumb throttle 129. The stand-alone single seat e-bike embodiment can be human pedal powered, electric hub motor 148 powered, or pedal assist (as you pedal the electric hub motor 148 assist). The primary frame 72 has a tool-less adjustable quill 100, with 2 pivot points, pivot point to handlebar 202 and pivot point from quill 204 as shown in FIG. 21, allowing for the toolless folding handlebars 210 to be positioned in the perfect position for the rider and to be positioned out of the way for storage. Located on the primary frame 72 is a chain guide/tensioner 130, it keeps the chain from contacting the e-bike footrest 120 when used, as a stand-alone single seat e-bike and or the rear connecting bar 50 when used as the quadracycle embodiment. Primary frame 72 also has a kickstand 152. Parts shown FIG. 5 but not used in this stand-alone single seat e-bike embodiment are the draglink mounting tab 96, tool-less quick-release outboard clamp primary 122, front canopy attachment points 88, rear canopy attachment points 74, toolless quick-release primary seat frame clamp 78, primary front seat attachment guide 134, and the armrest positioning clips 132.

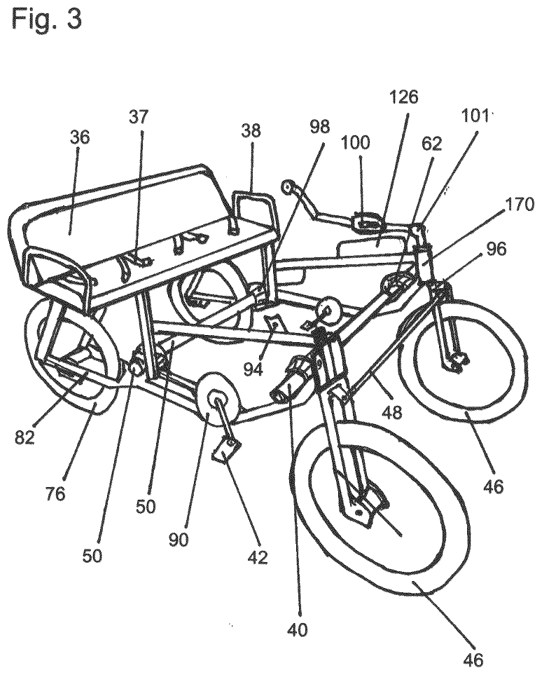

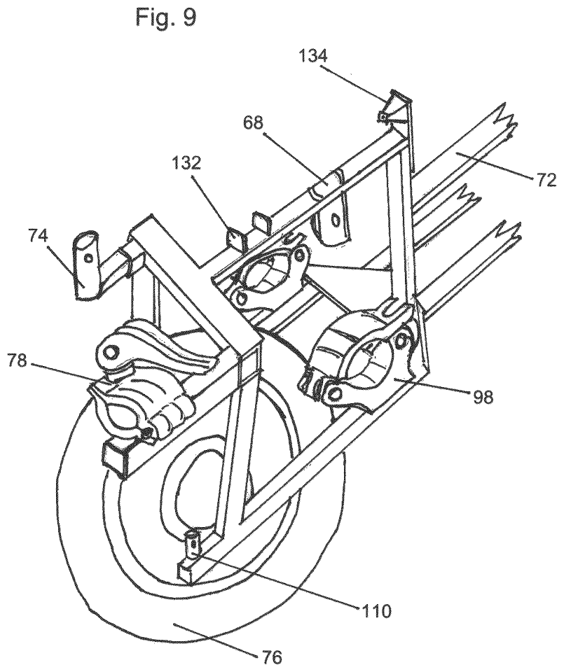

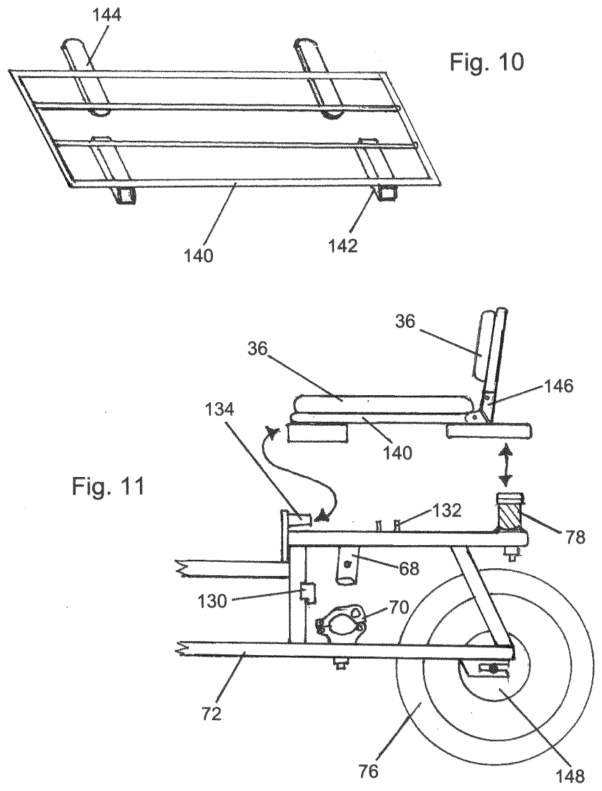

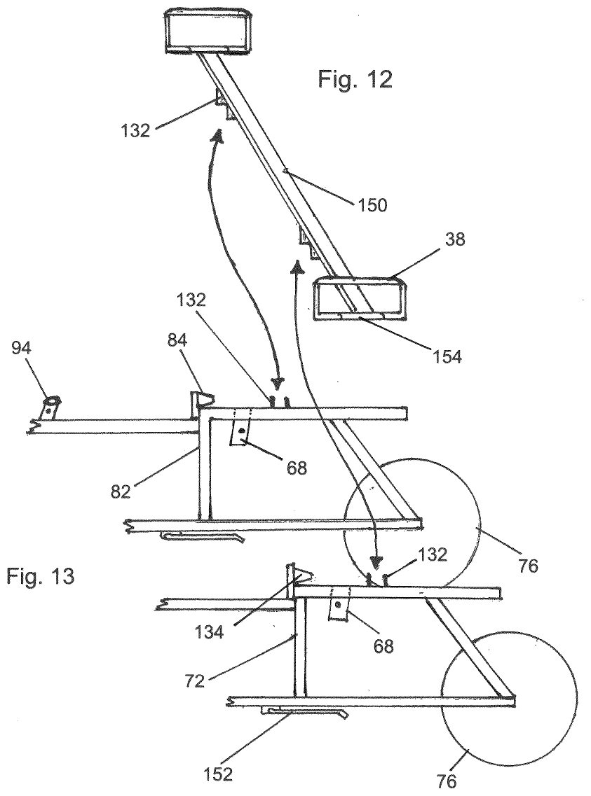

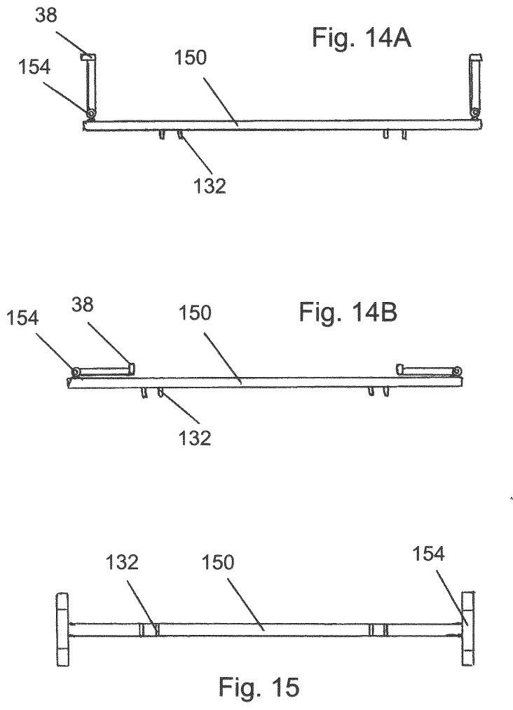

Quadracycle embodiment seating. FIG. 12 illustrates the assembly of the quadracycle embodiment relating to the armrest assembly 150, being installed. It must be set in place before the three-person folding seat 36 is installed. First refer to FIG. 14B, it shows the armrest assembly 150, in the folded (down) position (this allows for storage). The armrest assembly 150 must be placed on the primary frame 72 and secondary frame 82, the use of the armrest positioning clips 132 are used to locate it in the proper position, they are located on the bottom of the armrest assembly 150 and on each of the frames, primary frame 72 and secondary frame 82, when they are engaged, as indicated by the arrows, the armrest assembly 150 will not move, the armrest 38, can be lifted into the upright position, like in the FIG. 14A. They rotate and stop via the armrest folding hinges 154. The armrest assembly 150 will be held in place only when the seat frame base 140 is set on top of it. Once the armrest assembly 150 is setting on the primary frame 72 and secondary frame 82 with the armrest 38 in the open position like in FIG. 14A, the three-person folding seat 36 can be installed. FIG. 11 illustrates the quadracycle embodiments, three person folding seat 36, and the way it is attached to the primary frame 72 and the secondary frame 82. FIG. 10 illustrates the three person folding seat 36 seat frame base 140, without the seat hinge 146 or the back rest and padding attached (these are removed for better illustration of the mounting areas) this illustration shows the seat frame base 140, and the mounting parts, seat connecting tubes 144 and square tubing housing 142, it is shown as square hollow section but can be of other shapes (not shown). In FIG. 11 the square tubing housing 142 is slid into the primary front seat frame attachment guide 134 (shown by arrows) and at the same time the secondary front seat frame attachment guide 84 on the secondary frame 82, this connection slides until it stops at the base, then the seat connecting tubes 144 of the seat frame base 140 are now sitting on the toolless quick-release primary seat frame clamp 78, and toolless quick-release secondary seat frame clamp 176, they will be closed and locked down with the cam levers 180 completing the three person seat 36 and armrest assembly 150. FIG. 3 notes seatbelts 37.

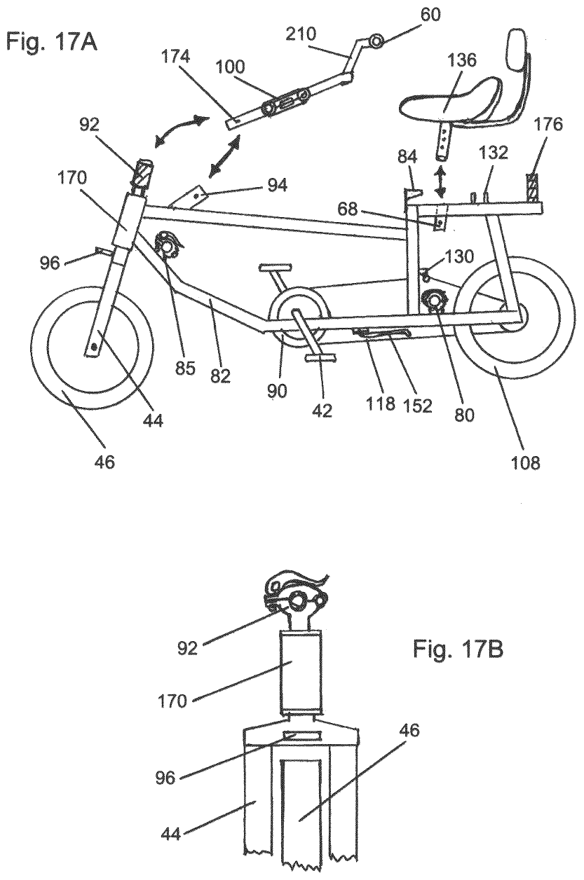

Regular bicycle mode. FIG. 17A is an illustration of the secondary frame 82 showing its use as a single person bike embodiment. This is achieved by inserting the handlebar assembly 174 into the secondary frame 82 via the toolless quick-release stem riser 92, this will allow for the “bike” to be steered by the rider, the secondary toolless quick-release stem riser 92 is a part that is not removed from the secondary frame 82. At this point the toolless handlebar clamping brake lever 196 is clamped to the toolless folding handlebar 210, it is always attached to the front brake 54 and the rear brake 106 of the secondary frame 82, it allows the rider the ability to stop. Next step, the single person seat 136 is slid into the single seat receiving tube 68 and a d-pin 116 is inserted at the proper height for the rider, this does not have to be limited to the d-pin 116 as it can also be a quick-release seat post collar clamp (not shown but commonly used on bikes), at this point the secondary frame 82 is ready to be ridden like a regular bicycle.

Also shown in FIG. 17A is the secondary handlebar attachment point 94, it is used when the secondary frame 82 is used as a Quadracycle, the handlebar assembly 174 is inserted into the secondary handlebar attachment point 94 and d-pin 116 into place.

The handlebar assembly 174 is then used as a place for the passenger to hold onto, not for steering. The top half of the handlebar assembly 174 is the toolless folding handlebars 210, it folds to make smaller for easy storage.

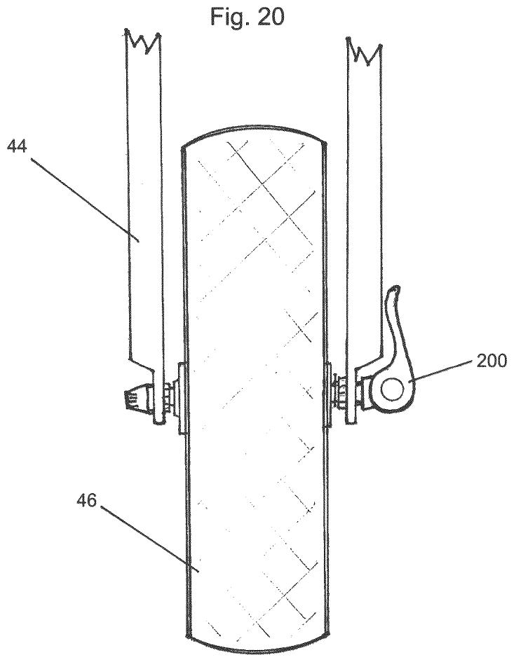

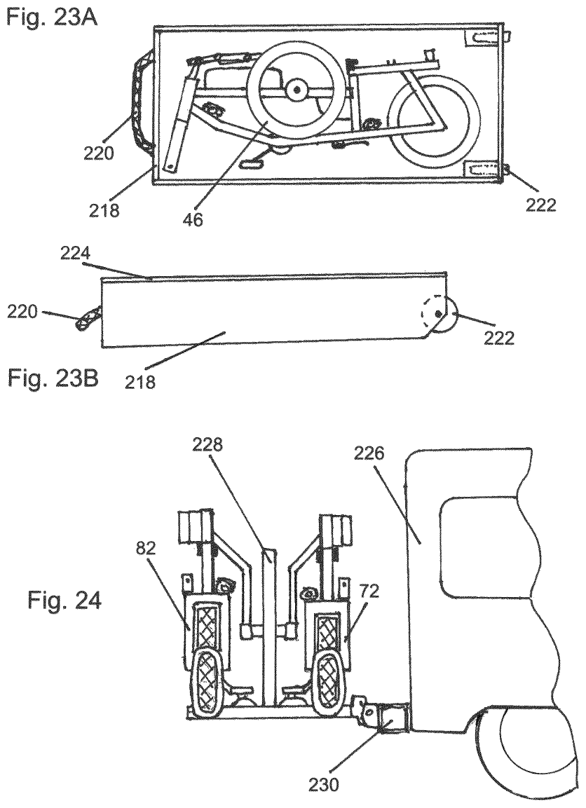

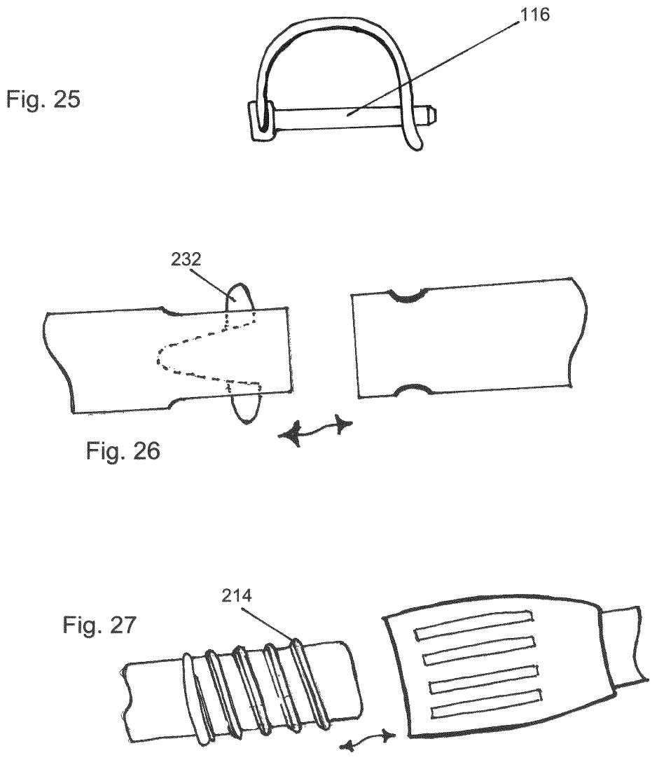

Transporting in boxes. FIG. 20 is an illustration of the front wheel 46, it shows a toolless quick-release hub skewer 200 that is used to remove the front wheel 46, by removing the front wheel 46 it allows for the storage box 218 to have been made smaller, saving space. The storage box 218 in FIGS. 23A and 23B is designed to hold a primary frame 72 in one storage box 218 and the secondary frame 82 in the other storage box 218, the storage boxes 218 are designed to also hold the handlebar assembly 174, the draglink 48, the front connecting bar 40, the rear connecting bar 50, the e-bike footrest 120, the single person seat 136, canopy poles 34, the canopy 32, the flexible solar panel 30, the armrest assembly 150, and the three person folding seat 36. The storage boxes 218 can be made of wood, plastic, fiberglass, carbon fiber or a combination of steel tubing and fabric. They are fitted with (out of the way) storage box wheels 222 at the rear and storage box handles 220 in the front, this makes for easy moving. Also, a storage box tops 224, used to keep everything clean and secure.

Transporting via bike rack. FIG. 24 is an illustration of transporting the 3 in 1 toolless quadracycle, with the use of a 2 bike platform bike rack 228 connected to the trailer hitch receiver 230 of a camper 226 (it can be used on anything with a trailer hitch), This will securely hold the two frames primary 72 and secondary 82. while the rest of the parts, the handlebar assembly 174, the draglink 48, the front connecting bar 40, the rear connecting bar 50, the e-bike footrest 120, the single person seat 136, canopy poles 34, the canopy 32, the flexible solar panel 30, the armrest assembly 150, and the three person folding seat 36, will fit into a canvas or plastic duffle bag (not shown) and placed on the rack also. Also not shown is a common two bike cover, it can be used to keep everything dry and clean while on the road.

Alternative embodiment. FIG. 26 is a toolless joint nut connector 214 used on the toolless folding handlebars 210 it could alternatively be used as a connector in other areas such as the rack attachment point 110 or the canopy poles 34 attachment, instead of the spring button tubing lock 232.

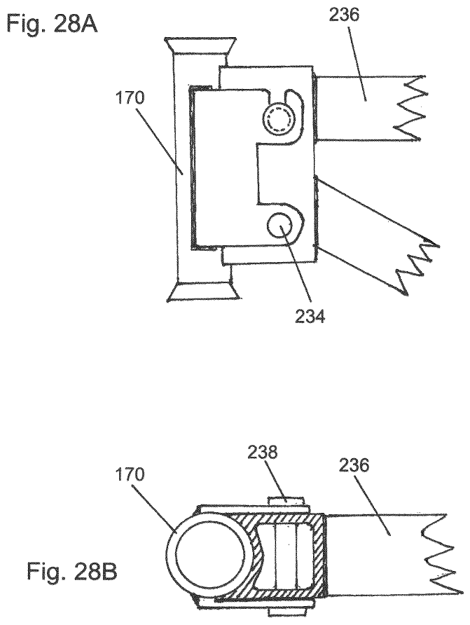

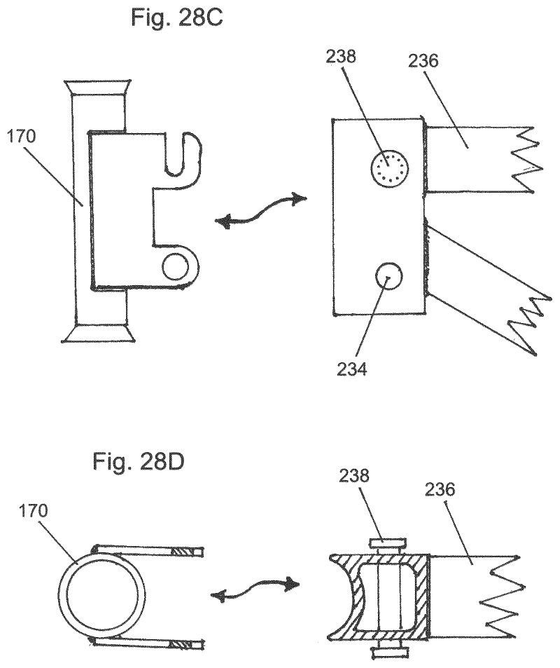

Alternative embodiment. FIGS. 27A, 27B, 27C and 27D are illustrations of an alternative embodiment to the primary frame 72 and secondary frame 82 that allows the front wheels 46, front forks 44 along with the head tube 170 and handlebar assembly 174 to remain connected together while being separated from the rear half of the primary frame 72 and secondary frame 82. It would require a single d-pin 116 to be removed from the d-pin locking area 234 and the front half lifted over the oversized head stud 238 as shown in FIGS. 28B, 28C and 28D this would allow the storage boxes 218 size to be much smaller, saving more space.

While the principles of this invention have been described in connection with specific embodiments, it should be understood clearly that these descriptions are made only by way of examples and are not intended to limit the scope of the invention. Many modifications are possible by substituting or adding alternative parts. The prior art of bicycles, e-bikes, quadracycles and golf carts is replete with examples of multiple versions of common parts including hinges, pivots, clamps, locking devices and catches which may be substituted. There are also many versions of means for common needs including: front wheel suspension, rear wheel suspensions, motor drive systems, seat angle adjustment, provision for mounting common accessories such as lights, racks, windshields, seat belts and others. Numerous modifications may be made to this invention without departing from its scope as defined in the appended claims.

As can be seen from this discussion, the quadracycle embodiment can be very rapidly assembled for use without tools and then when the use is finished, it can be very rapidly disassembled without the use of tools for storage and or transport. When assembled it is a full sized vehicle capable of comfortably transporting multiple individuals, however when it is not needed it can be rapidly transformed into an e-bike and or pedal bike, without the use of any tools, and placed into storage boxes 218 for storage or transport. The ability to disassemble into a small size is a significant advantage of the invention over prior art. These advantages are brought about by a novel structural attachment configuration in combination with novel toolless connections, resulting in minimum size, weight, time, and cost.

I claim:

1. A transformable vehicle system comprising:
(a) a bicycle frame configured to support a rider and provide propulsion;
(b) an electric motor coupled to the bicycle frame for motorized assistance;
(c) a set of toolless transformation components configured to attach to the bicycle frame, enabling conversion between a two-wheeled bicycle, an electric bicycle, and a four-wheeled quadracycle;
(d) an adjustable steering system with alternative steering linkage modifications to accommodate variations in steering offset distances;
(e) a flexible solar panel mounted to a canopy structure for auxiliary power generation;
(f) a luggage rack and wheeled storage boxes for additional cargo capacity and storage;
(g) a modular seating configuration with an optional footrest for a middle passenger and an alternative rear-facing seat in place of the cargo rack;
(h) a frame constructed from aluminium, steel, or carbon fiber to accommodate varying weight and durability requirements;
(i) a set of seatbelts for occupant safety;
(j) a power system compatible with multiple battery types, including but not limited to lithium-ion;
(k) a set of foldable armrest for user comfort;
(l) a braking system adaptable to various brake types; and
(m) a wheel assembly configured such that a front track width is wider than a rear track width to enhance handling and stability, wherein the wheel assembly may further include a suspension system;
wherein the toolless transformation components allow the bicycle frame and electric motor-powered bicycle frame to be reconfigured into a quadracycle without the need for tools.

2. The transformable vehicle system of claim 1, wherein the alternative steering modifications include an adjustable linkage system to accommodate different frame configurations and rider preferences.

3. The transformable vehicle system of claim 1, wherein the flexible solar panel is configured to provide supplementary power to the electric motor or auxiliary electrical components.

4. The transformable vehicle system of claim 1, wherein the modular seating arrangement allows for reconfiguration between cargo transport and additional passenger seating.

5. The transformable vehicle system of claim 1, wherein the frame material is selected based on the desired balance of weight, durability, and cost efficiency.

6. The transformable vehicle system of claim 1, wherein the braking system is adaptable to multiple braking technologies, including disc brakes or cantilever brakes.

7. The transformable vehicle system of claim 1, wherein the wheel assembly includes a suspension system to enhance ride comfort and stability over uneven terrain.

8. The transformable vehicle system of claim 1, wherein the bicycle and e-bike modes allow independent operation separate from the quadracycle configuration.
